(19) United States
(12) Patent Application Publication
(10) Pub. No.: US 2006/0120005 A1
(43) Pub. Date: Jun. 8, 2006

(54) Transient voltage surge suppression systems

(76) Inventor: Robert Jackson Van Sickle, Richmond City, VA (US)

Correspondence Address: ROBERT J. VAN SICKLE;THOR SYSTEMS, INC., 3621 SAUNDERS AVENUE, RICHMOND, VA, 23227-4354, US

(21) Appl. No.: 11/272,941

(22) Filed: Nov. 14, 2005

Related U.S. Application Data
(60) Provisional application No. 60/627,852, filed on Nov. 15, 2004.

(51) Int. Cl. H02H 9/06

(52) U.S. Cl. 361/118

(57) ABSTRACT

A surge-suppression system utilizing a hybrid design comprised of metal oxide varistors, silicon avalanche diodes, a fuse element, filter capacitor and multiple surge planes and surge paths to dissipate and divert transient over-voltages away from sensitive electronic equipment. These multiple surge conduction paths provide redundant parallel planes which optimize the skin-effect phenomena, which is the flow of electrical current at the conductor surface. This design provides a very low impedance which produces a high performance surge-suppression system.

### CROSS REFERENCE TO RELATED APPLICATION

This application discloses and claims subject matter which was disclosed in copending provisional patent application Ser. No. 60/627,852, filed Nov. 15, 2004.

### FIELD OF THE INVENTION

The present invention relates to electrical power quality and, more particularly, to Transient Voltage Surge Suppression (“TVSS”) devices that suppress transient over-voltages. Typically such devices are connected in parallel to the components and equipment to be protected and effectively reduce the transient over-voltage sufficiently low to ensure the survival of the protected equipment.

### BACKGROUND OF THE INVENTION

It is well known that commercially available electrical power quality is often inadequate for a number of applications—i.e., computers, communications equipment, medical equipment, CAD/CAM systems, automated manufacturing and process control. Specifically, voltage transients can cause sensitive electronic equipment to fail catastrophically or may degrade it so as to shorten its useful life—causing a possible loss of product, time, money and even human life.

Transients in electrical circuits result from the sudden release of previously stored energy. This energy can be stored within the circuit and released by a voluntary or controlled switching action or it can be from released energy outside the circuit and injected or coupled into the circuit.

Transients may occur either in repeatable fashion or as random impulses. Repeatable transients, such as commutation voltage spikes, inductive load switching, etc., are more easily observed, defined and suppressed. Random transients are more elusive. They occur at unpredictable times, often at remote locations, and require installation of monitoring instruments to detect their occurrence.

Frequently, transient problems arise from the power source feeding the circuit. These transients create the most consternation because it is difficult to define their amplitude, duration and energy content. The transients are generally caused by switching parallel loads on the same branch of a distribution system, although they also can be caused by lightning.

It is well known that TVSS systems utilize a number of suppression elements. Many are shunt devices attached in parallel with the utility power source. These elements try to direct the surge away from sensitive electronic equipment by providing a lower impedance conducting path to ground.

### SUMMARY OF THE INVENTION

The present invention is a surge-suppression system utilizing multiple, independent, parallel surge planes and surge paths to dissipate and divert transient over-voltage away from sensitive electronic equipment. By utilizing multiple parallel surge paths, the invention optimizes the “skin-effect” phenomenon, which is that the flow of electrical current is greatest at the conductor surface. As the frequency of the system increases, so does the rate of alternating flux, thereby intensifying the skin-effect condition. In a typical transient event, frequencies of up to 50 kHz are not uncommon; thus, skin-effect should always be taken into consideration in the design of transient and surge-suppression systems. The invention combats the issues created by skin-effect currents by placing the conductors in parallel, in effect increasing the surface area for the high frequency current to conduct. The invention also lowers the overall impedance of the system by applying multiple conduction paths.

The invention utilizes a hybrid surge-suppression system, comprising filter capacitors, high power suppression diodes (SADs), high energy metal oxide varistors (MOVs), a matching surge-rated suppression fuse and independent full surge, capacity-rated (for example, fill 5 oz. ×0.400″) copper parallel plane surge paths. These parallel paths are key elements in providing improved transient suppression performance. The improved suppression performance is accomplished by offering a lower impedance path between the hybrid design suppression elements and their conduction paths to direct the transient away from the protected equipment. This is accomplished by a primary, multi-layer printed circuit board (“PCB”) which has heavy copper parallel plane surge conduction paths on the outer top layer and the outer bottom layer.

The multiple, independent, parallel surge path planes and buss works enable the invention to have a small overall product package size. This smaller, more effective design increases overall system performance with improved suppression and requires less installation space (which translates to a smaller required footprint), thus allowing closer positioning of the suppression system to the sensitive load source and effectively requiring shorter lead lengths to further reduce the impedance of the overall surge conduction paths.

The smaller footprint permits the system to be installed close to the load source and, in addition, encourages the installer to install it in that location. It is important that a surge suppressor be installed as close as possible to the load source (e.g., on a wall immediately adjacent a wall-mounted electrical panel), in order to reduce the impedance. The smaller the footprint, the less the likelihood that the owner or installer of the surge suppressor will choose to locate it further from the source (i.e., on the other side of the room, connected by a wire to the panel).

The invention will be described in terms of two specific embodiments—a first embodiment which is simple (“TSn”) and a second embodiment which is more complex (“TSr”). In these designations, which are used for commercial products, “TS” refers to THOR SYSTEMS and “n” and “r” refer to components of the embodiments being non-replaceable and replaceable, respectively. It will be understood that these are only two of many possible embodiments, and that there may be many possible variations within each embodiment.

The TSn40 kA non-replaceable surge-suppression assembly or system is a product series which is a self-contained, hybrid design system. This TSn Series of products is typically applied to lower-branch circuits and sub-distribution panel boards.

The TSr160 kA surge-suppression assembly or system is a product series which is a very robust and feature-filled product, with field-replaceable service modules. This series of products furnishes the highest level of transient and electrical noise protection, typically applied at the electrical service entrance.

The term “MOV” refers to a Metal Oxide Varistor. This family of transient voltage suppressors is made of sintered metal oxides, primarily zinc oxide with suitable additives. These MOVs are industrial, high energy metal oxide varistors. They are designed to provide surge suppression in A/C mains and service entrance environments.

The term “SAD” refers to a Silicon Avalanche Diode. The SAD is considered to be the closest to the ideal transient suppression device and has the fastest response time of any suppression element. Typically, the SAD response time is given as less than one nanosecond.

For example, a TSr160 kA suppression assembly requires a 20″ H×6″ W×8″ D enclosure. By utilizing the stacked tier design concept, the multiple surge path design is retained and the TSr320 kA suppression assembly which carries twice the surge-current rating and a double tier of suppression components maintains the identical footprint of the TSr160 kA, adding only 4″ to the depth dimension. The above-described inventive TSr design is applicable to the most critical service entrance applications.

Service entrance and main distribution panel applications require the more robust and feature-filled TSr suppression system. As a result of a stringent and higher power system application, the inventive design utilizes multi-layer printed circuit cards with the ability to apply heavy copper parallel plane surge conduction paths on the outer top layer and the outer bottom layer, with the inner 1 oz. conventional layers dedicated to logic circuit traces. The TSr design offers additional multiples of the parallel surge conduction paths. In this system there are ten separate surge paths which are made possible by adding multiple printed circuit cards (multi-layer base PCB, single-layer bridge PCB and single-layer module PCB). All three of these PCBs are inventive designs with parallel full copper surge path planes incorporated on the top and bottom layers and the addition of solid copper buss bars bolted to the bottom layer of the multi-layered base PCB, providing a third solid copper buss works parallel surge path plane.

Critical service entrance applications are typically 24/7 operational requirements of large data processing and computer centers, requiring the highest level of surge suppression such as the TSr320 kA. This design also utilizes the inventive concept to assure the ultimate in surge-suppression system performance. In TSr systems, there are two tiers of suppression assemblies. On the lower tier there are ten separate surge paths and on the upper tier there are also ten separate surge paths. The two parallel tiers provide 320 kA of suppression capacity.

### BRIEF DESCRIPTION OF THE DRAWINGS

The invention will be described in detail with reference to the following figures:

FIG. 1 is a plan view of a TSn40 kA suppression system.

FIG. 2 is a side elevation of a TSn40 kA suppression system shown in FIG. 1.

FIG. 3 is a plan view of a TSr60 kA suppression system.

FIG. 4 is a bottom elevation of a TSr160 kA as shown in FIG. 3.

FIG. 5 is a plan view of a TSr320 kA replaceable module suppression system.

FIG. 6 is a bottom elevation of a TSr320 kA as shown in FIG. 5.

FIG. 7 is a sectional view of a double-sided printed circuit board.

FIG. 8 is a sectional view of a multi-layered printed circuit board.

FIG. 9 is an electrical schematic of a TSn40 surge suppressor.

FIG. 10 is an electrical schematic of a TSr160 surge suppressor.

FIG. 11 is an electrical schematic of a TSr80 surge suppressor.

FIG. 12 is a perspective view of a TSn40 surge suppressor shown in FIG. 1 and FIG. 2.

FIG. 13 is a perspective view of a TSr320 surge suppressor shown in FIG. 5 and FIG. 6.

FIG. 14 is another perspective view of TSr320 surge suppressor shown in FIGS. 5, 6, and 13.

### DESCRIPTION OF THE PREFERRED EMBODIMENTS

Directional terms used in this application assume an orientation of a TVSS system wherein its circuit board is horizontal with its MOVs facing upward. Of course, the systems may be otherwise oriented when they are manufactured, assembled, handled, shipped, sold, installed, used or repaired.

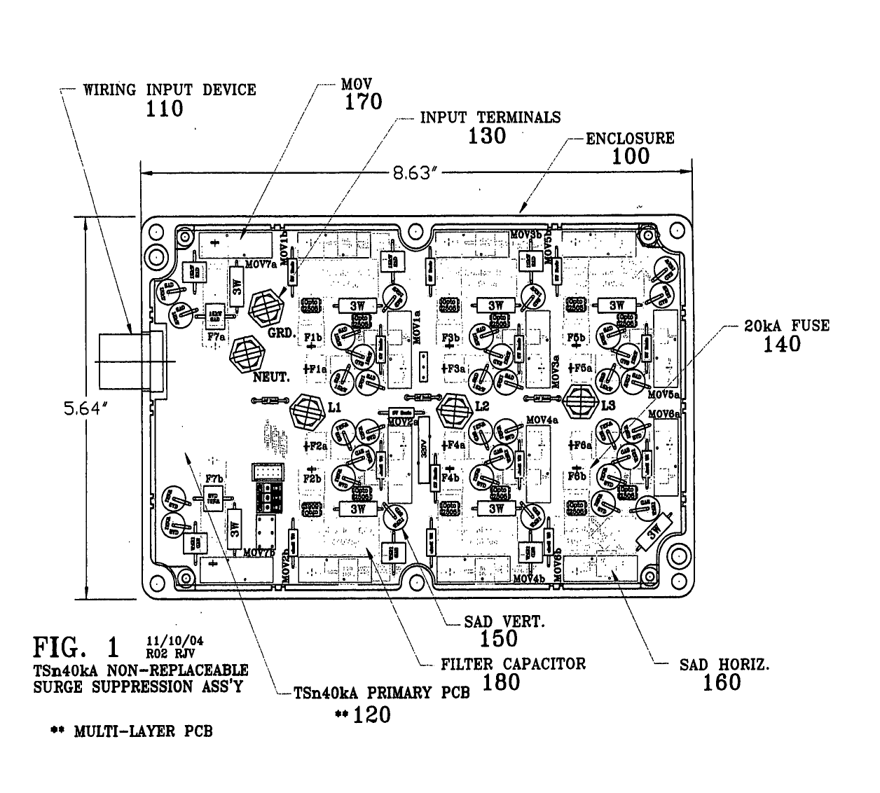

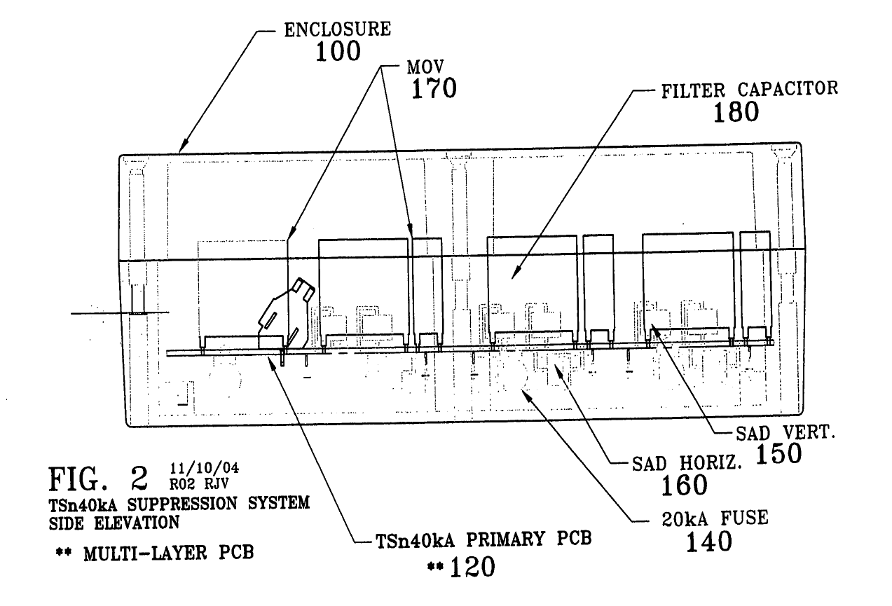

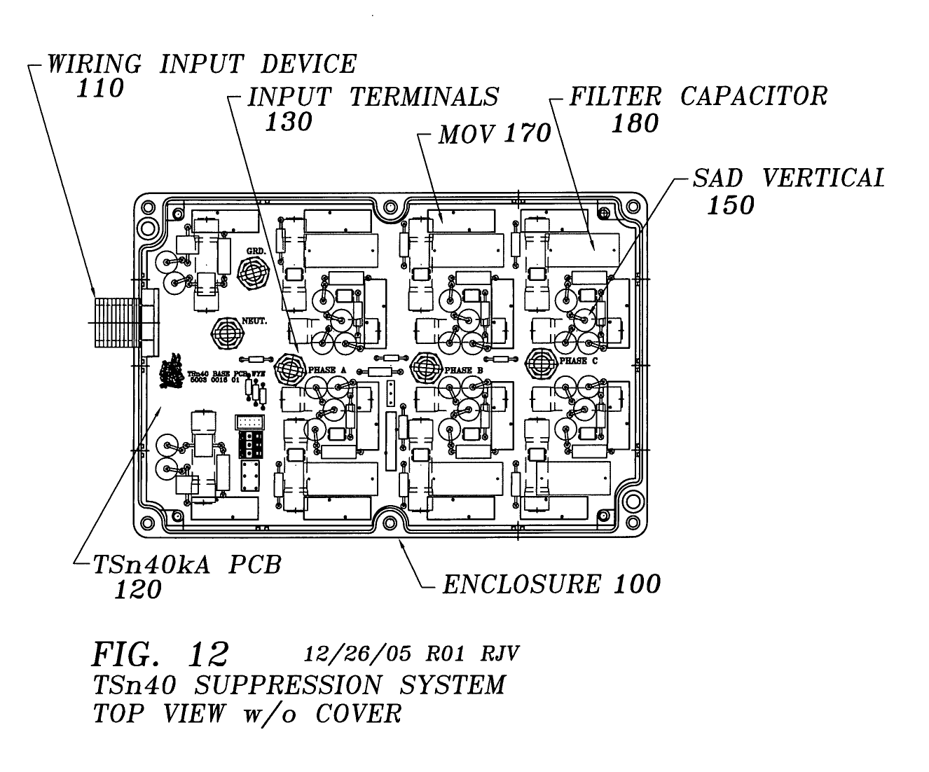

FIGS. 1, 2 and 12 show a TSn40 kA non-replaceable surge-suppression system. This is a system connected in parallel with electrical source supplying sensitive electronic equipment. The input supply source conductors are passed through the wiring input fitting 110 and terminated in the appropriate input terminals 130. There are five input terminals—one for neutral, one for ground, and one for each phase of a three-phase WYE connected electrical service (i.e., L1, L2 and L3). This is a hybrid design, consisting of a TSn40 kA PCB 120, an array of high-power Silicon Avalanche Diodes (SADs) assembled in a vertical 150 and a horizontal 160 configuration with Metal Oxide Varistors (MOVs) 170 and an independent filter capacitor 180 for each mode of suppression L:N and L:G. Each suppression element array is protected by a 20 kA fuse 140 which is full surge-rated. This TSn40 kA system utilizes paralleled 20 kA rated arrays. The unique inventive design concept uses multiple parallel 5 oz.×0.400″ surge paths. These heavy copper printed circuit board traces also interconnect the individual components of the suppression arrays, thus allowing a very concise, low impedance surge-suppression design. FIG. 2 clearly depicts the nested surge suppression components within the die-cast aluminum enclosure 100.

The inventive design concept of multiple parallel surge paths provides the opportunity to utilize both sides of the TSn40 kA printed circuit board 120. Another distinct advantage of placing components on both the top and bottom sides of the printed circuit boards is isolation of the 20 kA fuse 140 from the MOVs 170. This isolation assures the fuse is not compromised in its ability to clear a faulted condition during a catastrophic failure of the MOVs. The SADs are also located on the top of the printed circuit board. In order to further enhance the low impedance SAD suppression arrays which are configured in a horizontal 160 and a vertical 150 arrangement, they are interconnected utilizing heavy copper parallel surge paths.

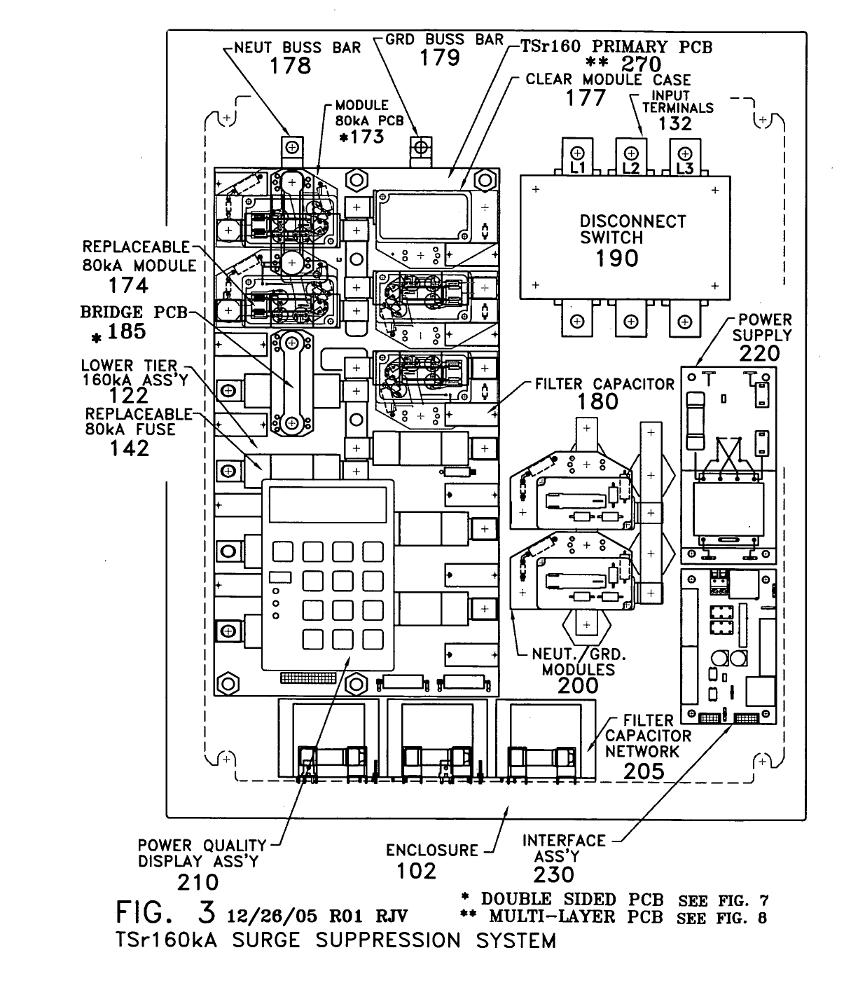

FIG. 3 shows a TSr160 kA surge-suppression system, which is designed for service entrance applications. It is in a three-phase, WYB configuration. The TSr Series products feature self-contained field-replaceable individual suppression modules. The key element and common building block of the TSr products is the 80 kA replaceable module 174. The foundation on which the replaceable module concept is built is the lower tier 160 kA PCB 122. On this PCB base, there are twelve assembled individual replaceable modules 174 and their respective, individual 80 kA replaceable fuses 142 and individual filter capacitors 180. To achieve the highest performance, we have utilized a novel bridged and stacked surge-suppression component geometry. The required footprint of a full surge-rated 80 kA replaceable fuse 142 necessitated a bridge concept in order to maintain tight component proximity and, therefore, low impedance surge paths. Close component relationships breed high performance surge suppression. To address catastrophic 80 kA MOV 172 failure, caused by transient surges beyond the rated value of energy and peak current, we have integrated full surge-rated fuses and shielding of the MOVs via a clear module case 177. The bridged and stacked design is achieved by the application of various multi-purpose standoffs.

The 160 kA surge suppression system is housed in enclosure 102. Within this enclosure are input terminals 132 located on the disconnect switch 190. Both the NEUT. buss bar 178 and the ground buss bar 179 are also fitted with their respective terminals for field-installed wiring by the end user.

The disconnect switch 190 provides the disconnect means to allow timely module replacement and field service requirements. The power supply assembly 220 provides logic power for the monitoring system 210. The interface assembly 230 is the end user's connection terminal point for inputs and outputs to the monitoring system 210. The TSr160 kA is provided with two separately monitored NEUT./GRD. modules 200 and a self-contained filter capacitor network 205, which provide electrical noise suppression.

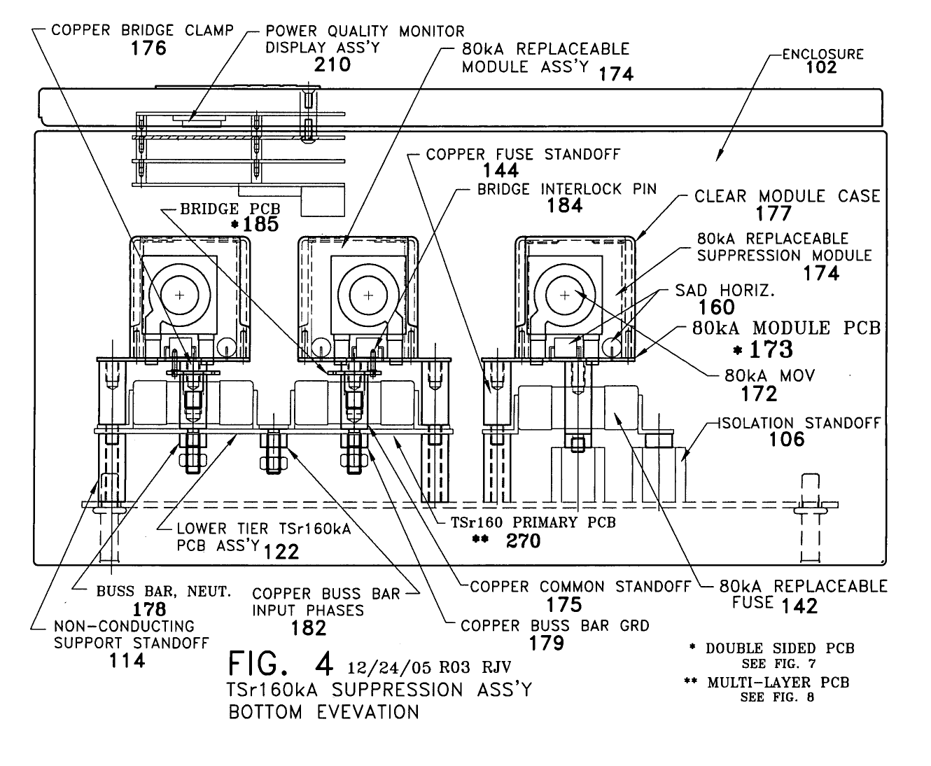

FIG. 4 shows the TSr160 kA suppression system. The non-conducting support standoff 114 supports the lower tier TSr160 kA PCB 270, 122 while the copper fuse standoff 144 provides a load-side fuse surge path to the suppression elements located on the 80 kA module PCB 173 and also supports the 80 kA replaceable module assembly 183 above the 80 kA replaceable fuse 142. The 80 kA MOV 172 and the horizontal SADs 160 are both system voltage dependent variable components, making their respective assembly system voltage dependent; therefore, each 80 kA replaceable module assembly 183 is voltage-keyed through the use of a bridge interlock pin 184. The module assembly 183 has a female receptacle and the bridge PCB 185 has a male bridge interlock pin 184 soldered in place to assure proper system voltage compatibility. The bridge PCB 185 provides the voltage keying requirement as well as another parallel surge-suppression path. The copper common standoff 175 supports and locates the bridge PCB 185 in place with the bridge clamp 176. This copper common standoff 175 performs yet another function of attaching buss bar GRD. 179, buss bar NEUT. 178, and copper buss bar input phases 134, 182. These three buss bars 178, 179, 182 are additional parallel surge paths which give the inventive system its outstanding surge-suppression performance. The isolation standoff 106 provides support for separately mounted NEUT. and GRD. modules. The power quality monitor display assembly 210 is a fully-integrated, feature-filled power quality monitoring system. This power quality monitor has full three-phase power analysis, waveform capture, harmonic distortion and three-phase, high-speed transient monitoring. The monitoring system display interface has alpha-numeric as well as graphic capabilities, with the ability to support remote monitoring through a wireless interface with outboard HTML web page server. The combination of these two systems will offer the customer features and capabilities heretofore not available in a single system.

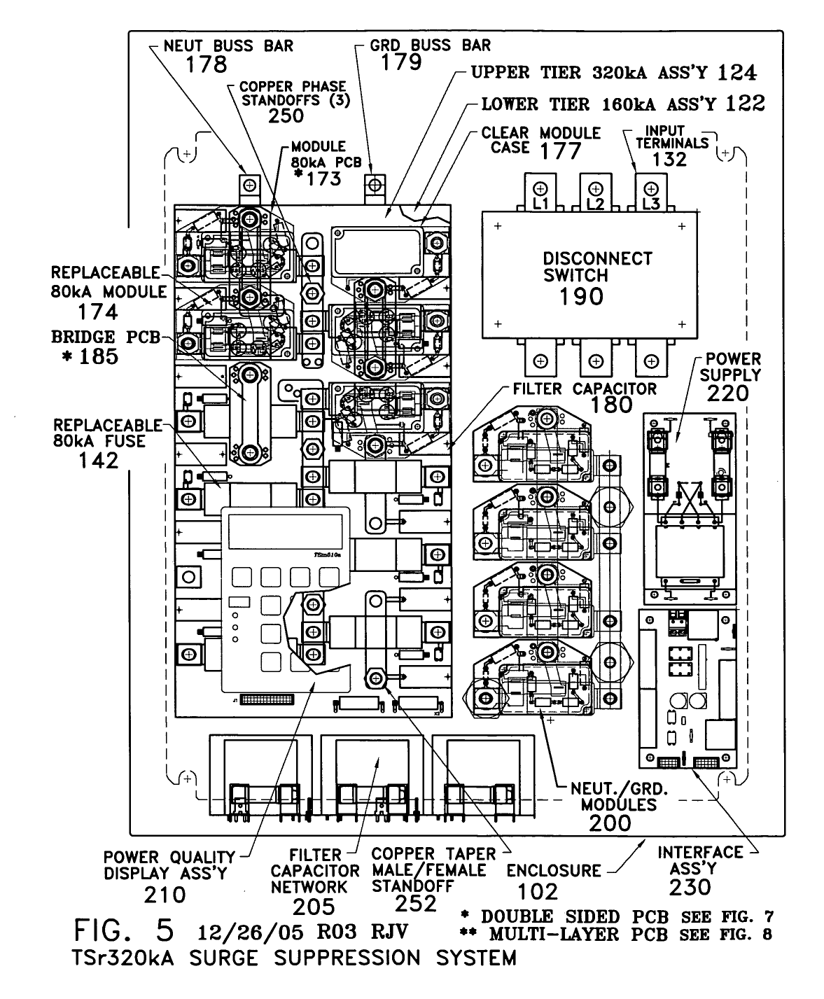

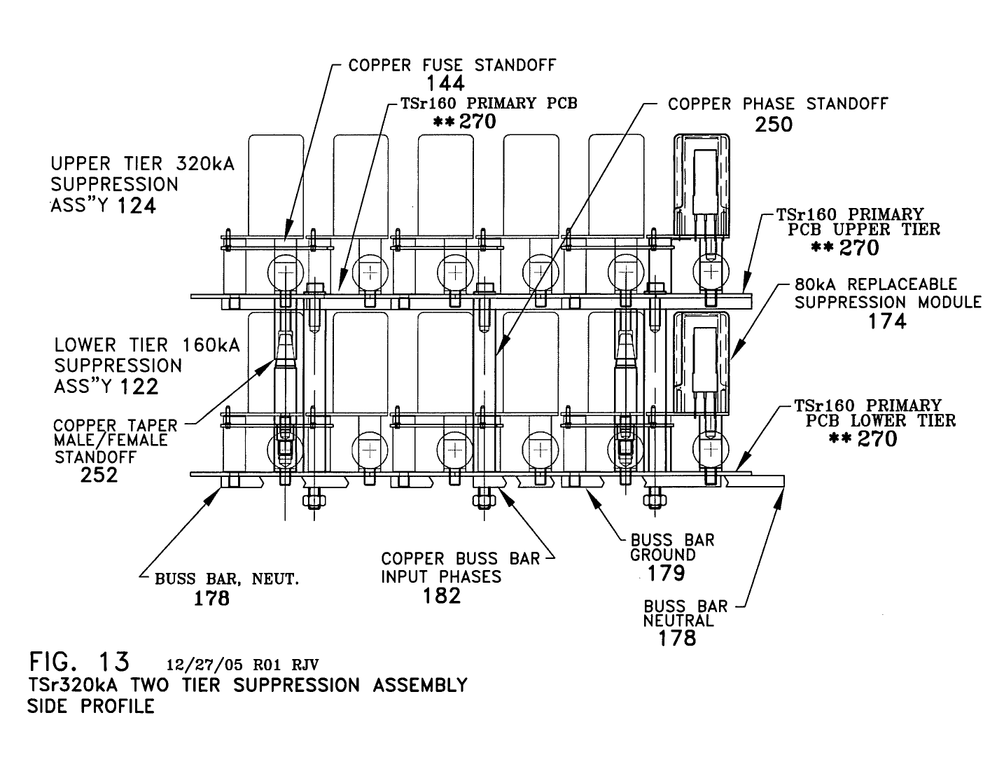

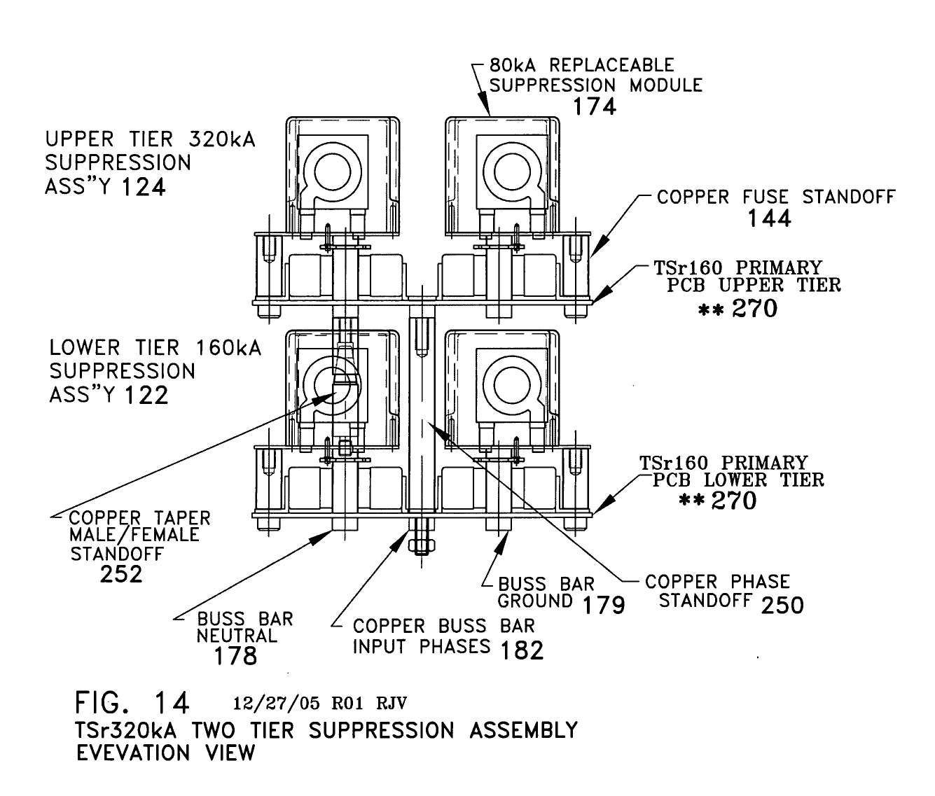

FIGS. 5, 6, 13 and 14 show a TSr320 kA surge-suppression system in three-phase WYE configuration. This system is designed for the most critical service entrance applications. This TSr320 product is believed to be the most feature-filled offering in the surge-suppression marketplace. Self-contained field replaceable modules are also featured in the TSr320 using the base lower tier 160 kA PCB assembly 122 as a foundation building block, holding twelve 80 kA replaceable modules 174 with the ability to stack an additional upper tier PCB assembly 124 which increments to twenty-four, the number of individual 80 kA replaceable modules all applied in a three-phase, surge-suppression configuration.

This stacking capability is accomplished through the unique application of copper-phase standoffs 250 and copper tapered male/female standoffs 252. These standoffs provide the mechanical structure rigidity as well as the necessary solid copper surge paths to the upper suppression tier 124. The enclosure TSr320 103 houses the lower and upper suppression tiers 122, 124 as well as four independent NEUT./GRD. modules 200. The TSr320 also features a surge-rated disconnect switch 190, logic power supply 220, interface assembly 230, filter capacitor network 205 and the power quality monitor display assembly 210 as described in FIG. 4.

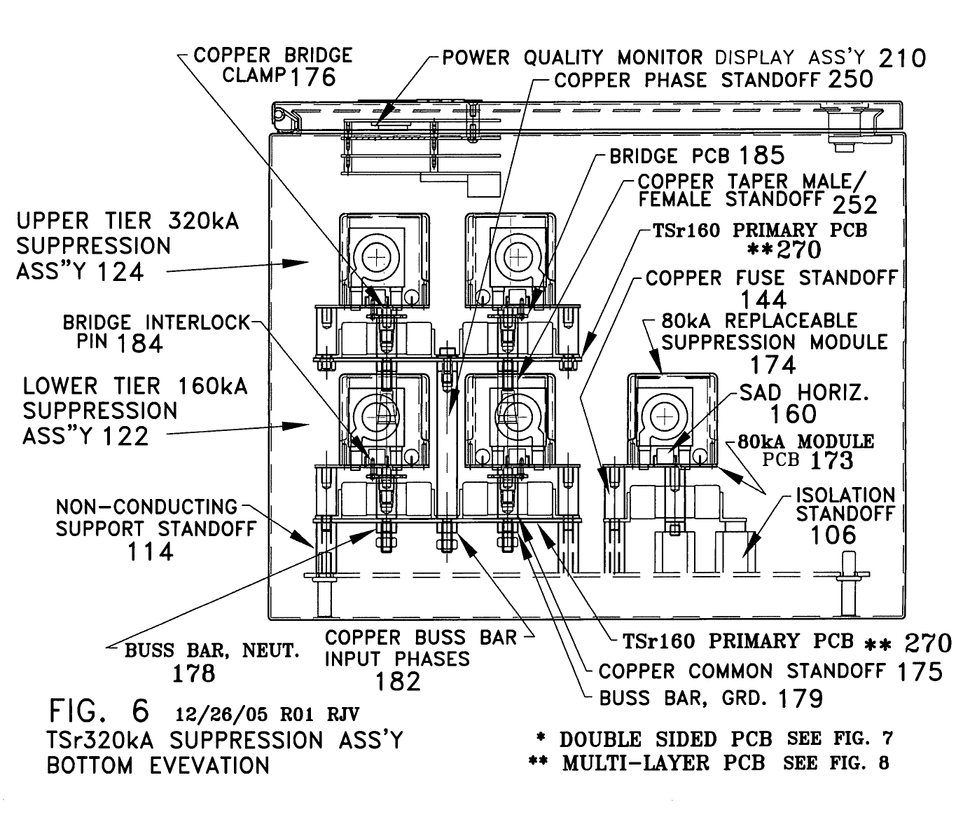

FIG. 6 is the bottom elevation of a TSr320 kA suppression assembly. This figure clearly delineates the lower and upper suppression tier assemblies 122, 124 and the relative positions of the copper phase standoff 250 and the copper tapered male/female standoffs 252. Each of the respective lower and upper tiers 122, 124 has multiple parallel surge-conduction paths. This tiered inventive design provides the ultimate performance utilizing low-impedance multiple parallel surge paths.

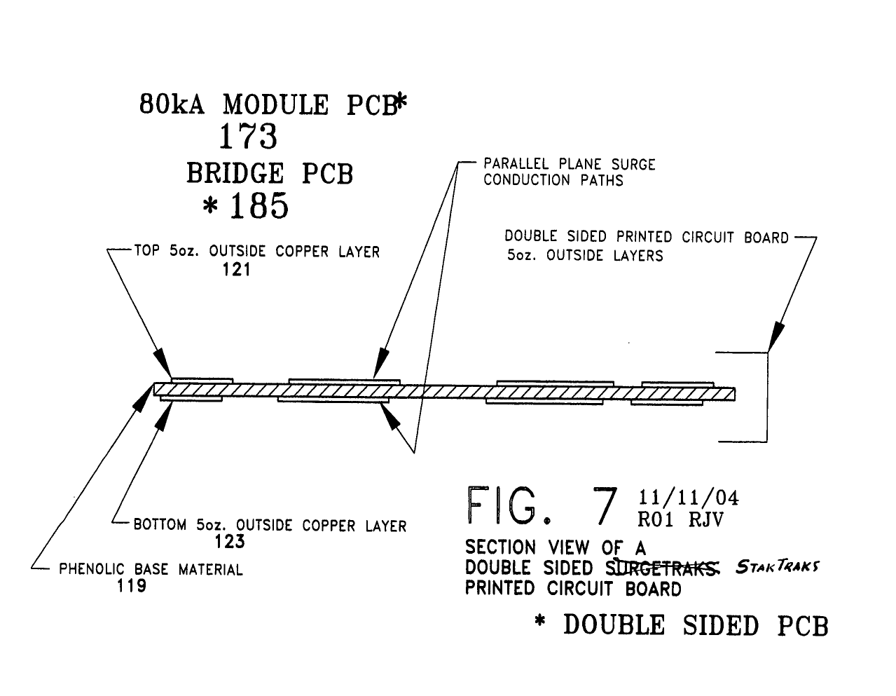

FIG. 7 shows a double-sided, single-layer inventive printed circuit board and depicts the phenolic base of PCB 119 with the top 5 oz. outside copper layer 121 and the bottom 5 oz. outside copper layer 123. These two outside 5 oz. copper bottom 123 and top 121 layers comprise the inventive parallel plane-surge conduction paths. Such a single-layer PCB is used for the bridge PCBs and module PCBs shown in FIGS. 3-6, 13 and 14.

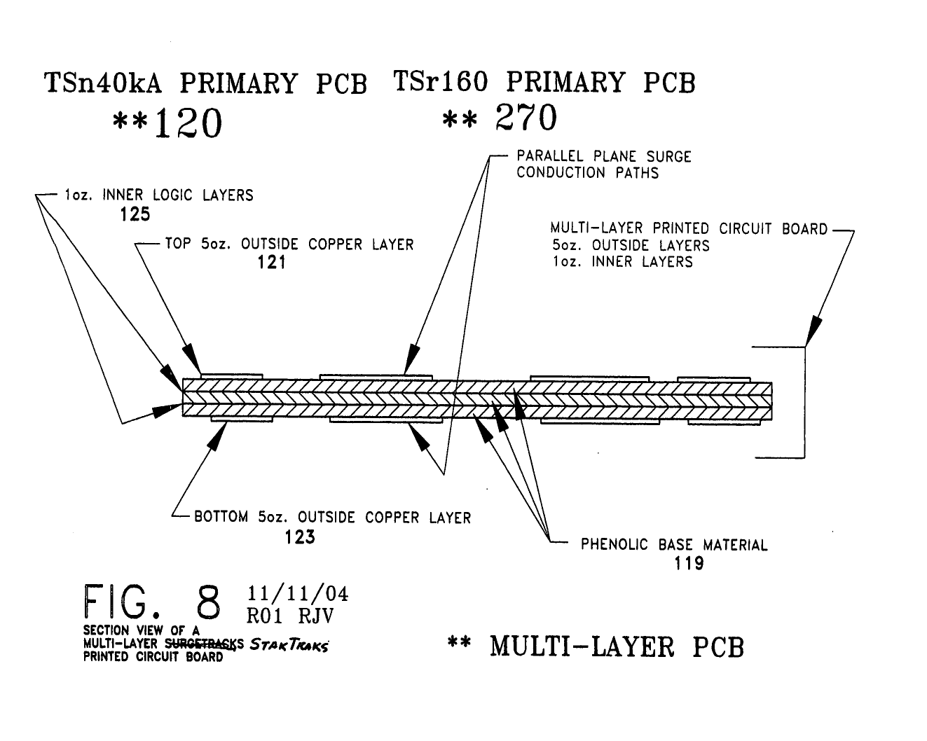

FIG. 8 shows a multi-layered printed circuit board according to the invention and shows, in cross section, the composite laminate makeup of a multi-layered printed circuit card. The top 5 oz. outside copper 121 and the bottom 5 oz. outside copper 123 provide the parallel low impedance surge paths. These two outer layers also provide heavy copper 5 oz.×0.400″ interconnections for the surge-suppression elements to further reduce the overall impedance and subsequent reaction times of the total suppression system. The phenolic base material 119 provides the structural rigidity and necessary isolation of the 1 oz. inner logic layers 125. These inner logic tracks interconnect the logic components and convey logic signals to the power-quality monitoring system. Such a multi-layer PCB is used for the only PCB in the embodiment shown in FIGS. 3-6, 13 and 14, and for the primary PCB in the other embodiments.

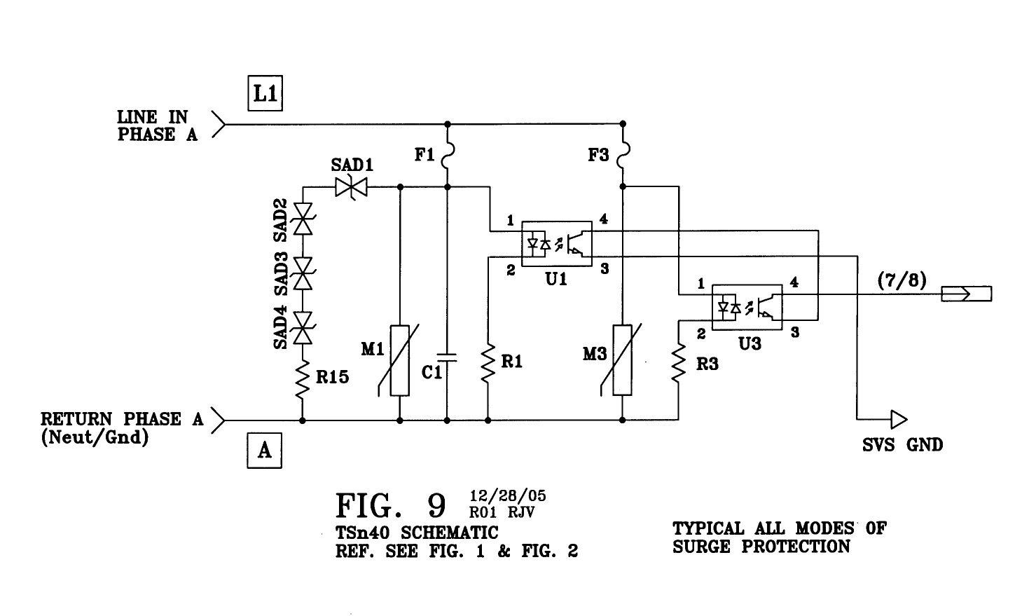

FIG. 9 is the electrical schematic of a TSn40 suppression assembly and shows the orientation and relationships of the surge-suppression components in a typical three-phase system. This schematic represents the physical assemblies shown on FIG. 1 and FIG. 2.

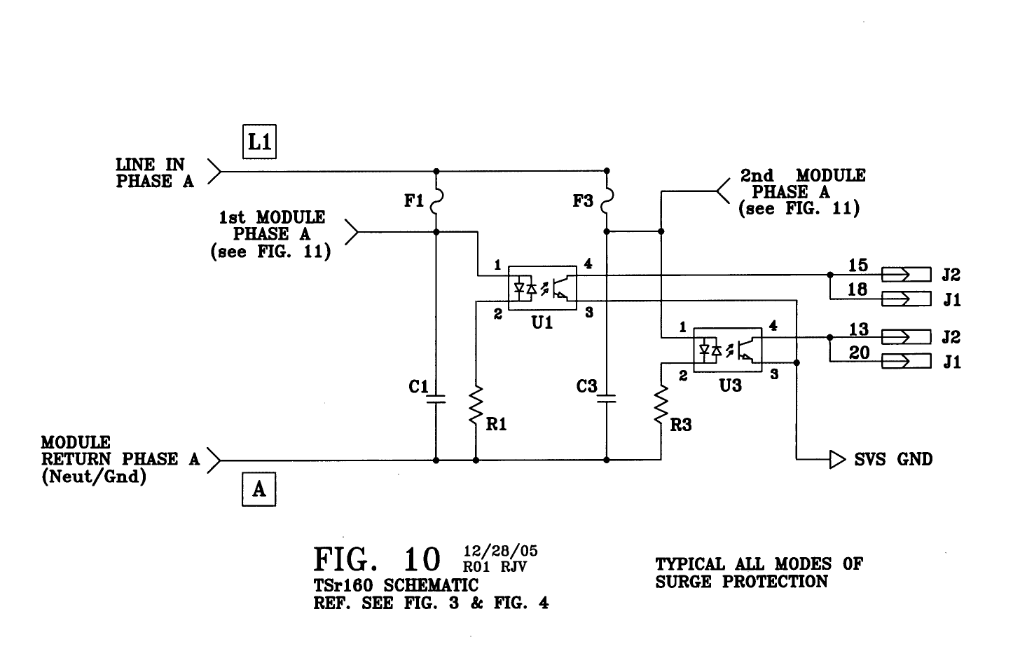

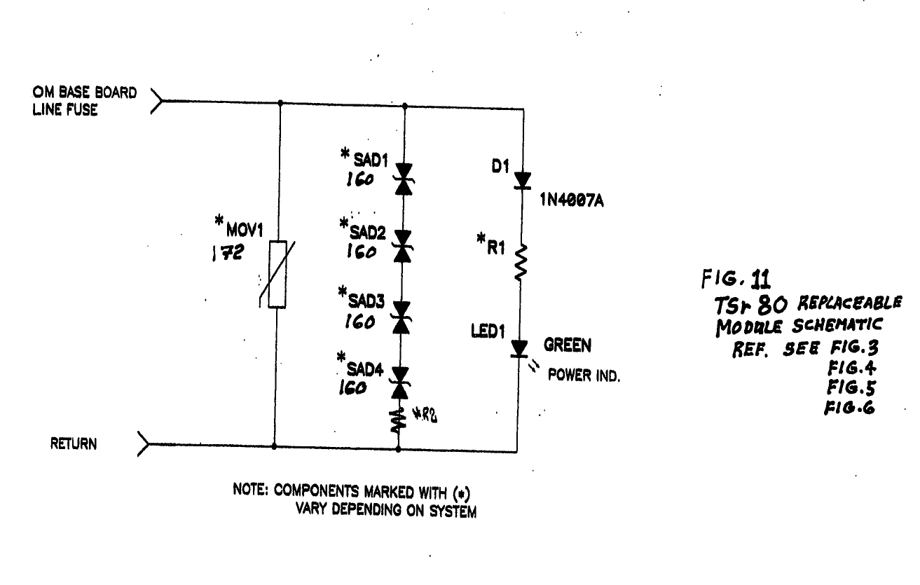

FIG. 10 is the electrical schematic of a TSr160 suppression assembly and shows the base PCB and its power A/C input circuits and relative fuses, 80 kA 142. See FIG. 11 for the suppression elements which are on their own PCB enclosed with a clear, protective polycarbonate case. This schematic represents the physical assemblies shown on FIG. 3 and FIG. 4.

FIG. 11 is the electrical schematic of a TSr80 replaceable module and shows the relationships of the MOV 172 and its associated array of SADS 160. This schematic represents the physical assemblies shown on FIGS. 3, 4, 5 and 6.

It will be understood that, while presently preferred embodiments of the invention have been illustrated and described, the invention is not limited thereto, but may be otherwise variously embodied within the scope of the following claims.

### Reference Character Table

The following table lists the reference characters and names of features and elements used herein, with asterisks indicating groups of features and elements:

| | | Paragraph | |
|---|---|---|---|
| Ref. | | Introduced | FIGS. |
| Char. | Feature or Element | In | Shown In |
| 100 | Enclosure | 0036 | 1, 2, 12 |
| 102 | Enclosure | 0039 | 3, 4 |
| 103 | Enclosure TSr320 | 0043 | 5 |
| 106 | Isolation Standoff | 0041 | 4, 6 |
| 110 | Wiring Input Device | 0036 | 1, 12 |
| 114 | Non-conducting Support | 0041 | 4, 6, 13 |
| | Standoff | | |
| 119 | Phenolic Base Material | 0045, 0046 | 7, 8 |
| 120 | TSn40 kA Primary PCB | 0036 | 1, 2, 8, 12 |
| 121 | Top 5-oz. Outside Copper Layer | 0045, 0046 | 7, 8 |
| 122 | Lower Tier 160 kA PCB Ass'y | 0038 | 3, 4, 5, 6, 13, |
| | | | 14 |
| 123 | Bottom 5-oz. Outside Copper | 0045, 0046 | 7, 8 |
| | Layer | | |
| 124 | Upper Tier 320 kA PCB Ass'y | 0042 | 5, 6, 13, 14 |
| 125 | 1-oz. Inner Logic Layers | 0046 | 8 |
| 130 | Input Terminals | 0036 | 1, 12 |
| 132 | Input Terminals | 0039 | 3, 5, 13 |
| 134 | Buss Bar Input Phases | 0041 | 13, 14 |
| 140 | 20 kA Fuse | 0036 | 1, 2 |
| 142 | 80 kA Replaceable Fuse | 0038 | 3, 4, 5, 13 |
| 144 | Copper Fuse Standoff | 0041 | 4, 6, 13 |
| 150 | SAD Vert. | 0036, 0037 | 1, 2, 12 |
| 160 | SAD Horiz. | 0036, 0037 | 1, 2, 4, 6, 11 |
| 170 | MOV | 0036 | 1, 2, 12 |
| 172 | 80 kA MOV | 0038, 0041 | 4, 11 |
| 173 | 80 kA Module PCB | 0041 | 3, 4, 5, 6, 7, 13, |
| | | | 14 |
| 174 | 80 kA Replaceable Module | 0038 | 3, 4, 5, 6, 13, |
| | Ass'y | | 14 |
| 175 | Copper Common Standoff | 0041 | 4, 6 |
| 176 | Copper Bridge Clamp | 0041 | 4, 6, 13 |
| 177 | Clear Module Case | 0038 | 4 |
| 178 | Buss Bar, Neut. | 0039, 0041 | 4, 6 |
| 179 | Copper Buss Bar Grd | 0039, 0041 | 4, 6 |
| 180 | Filter Capacitor | 0036 | 1, 2, 12, 13 |
| 182 | Copper Buss Bar Input Phases | 0041 | 4, 6 |
| 184 | Bridge Interlock Pin | 0041 | 4, 6 |
| 185 | Bridge PCB | 0041 | 3, 4, 5, 6, 7, 13, |
| | | | 14 |
| 190 | Disconnect Switch | 0039, 0040 | 3, 5 |
| 200 | Neut./Grd. Modules | 0040 | 3, 5 |
| 205 | Filter Capacitor Network | 0040 | 3, 5 |
| 210 | Power Quality Monitor Display | 0040, 0041 | 3, 4, 5, 6 |
| | Ass'y | | |
| 220 | Power Supply Ass'y | 0040 | 3, 5 |
| 230 | Interface Ass'y | 0040 | 3, 5 |
| 250 | Copper Phase Standoff | 0043 | 5, 6, 14 |
| 252 | Copper Taper Male/Female | 0043 | 5, 6, 14 |
| | Standoff | | |
| 270 | TSr160 Primary PCB | 0041 | 4, 5, 6, 8, 13, |
| | | | 14 |

What is claimed is:

1. A unitary, compact, low impedance surge suppressor for suppressing transient voltage surges, which suppressor comprises:
(a) a metal oxide varistor for conducting current to ground if voltage exceeds a predetermined value;
(b) a silicon avalanche diode for rapidly conducting current to ground if the voltage exceeds a predetermined value;
(c) a destructible fuse for protecting said system if current exceeds a predetermined value;
(d) a capacitor for filtering electrical noise; and
(e) a composite printed circuit board comprising at least three flat, rigid layers of non-conducting material, which layers include a top layer, a bottom layer and at least one intermediate layer between the top and bottom layers;
(f) copper surge-conducting traces adhered to outer surface of the top layer;
(g) copper surge-conducting traces adhered to outer surface of the bottom layer; and
(h) copper signal-conducting traces disposed adjacent one surface of the intermediate layer;
(i) said traces connecting said varistor, diode, fuse, and capacitor, with the surge-conducting traces adhered to the top layer being in parallel electrical relationship with the surge-conducting traces adhered to the bottom layer.

2. A surge suppressor according to claim 1 wherein the cross-sectional areas of the surge-conducting traces are substantially greater than the cross-sectional areas of the signal-conducting traces.

3. A surge suppressor according to claim 1 wherein the cross-sectional areas of the surge-conducting traces at least 100 times greater than the cross-sectional areas of the signal-conducting traces.

4. A surge suppressor according to claim 1 wherein the surge-conducting traces on the top layer and the surge-conducting traces on the bottom layer are in parallel geometric relationship.

5. A surge suppressor according to claim 1 wherein the aggregate current-carrying capacity of the surge-conduction traces on the top layer is within the range of from 50 percent to 150 percent of the aggregate current-carrying capacity of the surge-conduction traces on the bottom layer.

6. A surge suppressor according to claim 1 wherein the aggregate current-carrying capacity of the surge-conduction traces on the top layer is approximately equal to the aggregate current-carrying capacity of the surge-conduction traces on the bottom layer.

7. A surge suppressor according to claim 1 wherein the fuse and the varistor are on opposite sides of the composite circuit board.

8. A surge suppressor according to claim 1 wherein the suppression elements, i.e., MOVs and SADs, are enclosed by a containment case, so as to shield the fuse from them.

9. A surge suppressor according to claim 1 wherein copper signal-conducting traces are disposed adjacent both surfaces of the intermediate layer.

10. A surge suppressor according to claim 6 wherein the current-carrying capacity of the traces on the top layer is at least as great as the full surge-rated capacity of the varistors, so that the traces on the bottom layer are redundant.
